(19) United States
(12) Patent Application Publication
(10) Pub. No.: US 2003/0136571 A1
(43) Pub. Date: Jul. 24, 2003

(54) Piovoting support for power tool

(76) Inventor: Terje Linberg, Austmarka (NO)

Correspondence Address: CALFEE HALTER & GRISWOLD, LLP, 800 SUPERIOR AVENUE, SUITE 1400, CLEVELAND, OH, 44114, US

(21) Appl. No.: 10/296,430

(22) PCT Filed: May 24, 2001
(86) PCT No.: PCT/GB01/02271

(30) Foreign Application Priority Data
May 24, 2000 (GB) 0012556.7
Sep. 4, 2000 (GB) 0021580.6

(51) Int. Cl. B25D 17/04

(52) U.S. Cl. 173/162.2

(57) ABSTRACT

A light-weight, easily manoeuvrable jig (30) comprised of a pole (8, 9) for resting on the ground or floor holds a powered tool (5) having a handle (5a). The pole includes a vertically expanding device (9) in the form of a pneumatic cylinder for lifting and lowering the tool (5). The tool (5) is mounted on the jig (30) in such a way that, by using the handle (5a), the tool (5) is, to a limited extent, universally angularly manoeuvrable with respect to the jig (30). Vibration-absorbing elastomeric sleeves (12) and (14) are located between the tool (5) and the jig (30) for absorbing vibrations caused by operation of the tool (5). The expanding device (9) is operated by the use of a pressure regulator valve (10) and a combined height-adjustment and air-release valve (11). In another embodiment, the expanding device (9) is operated by trigger (17) of the tool (5), the pressure in the expanding device being controlled by the pressure regulator valve (10). In a further embodiment the expanding device (9) is simply operated using the trigger (17) of the tool (5).

This invention relates to the use of a powered tool for working at material, e.g. for overhead to horizontal tooling of concrete, masonry and other building materials.

In the building and construction industry there is a constant need for chiselling and drilling operations on concrete, masonry and similar building materials. Such chiselling and drilling is usually done using hand-held pneumatic, hydraulic or electric chiselling or drilling tools. These tools incorporate a hammer action which greatly accelerates the chiselling or drilling effect. The hammer action results in considerable vibration which is transmitted through the tool into the worker's arms and body. This vibration can eventually result in tissue damage and can seriously impair health. In addition, the tools weigh around 2 kg to 3 kg in themselves, and, with the addition of the bit, their total weight can reach 5 kg or more. In particular, using hand-held tools for overhead work is extremely tiring, and entails frequent rest intervals. Often, workers can manage this type of work for no longer than about 2 hours per working day, and it is becoming more and more difficult to find people who are willing to perform such work.

Partial solutions to this problem are to be found in chiselling robots, of which there are several on the market. These machines tend to be large and heavy, and suited only to heavy structures where the structure itself can carry the robot's weight, and where areas to be chiselled are large enough to make the use of such a robot economically feasible. Smaller machines are also to be found, but are still too large, heavy and inflexible to be of use in general construction work, particularly when working on scaffoldings or balconies above ground level.

EP-A-391613 discloses a paving breaker wherein vibrational forces arising from reciprocation of the breaker are decoupled from the breaker handles by mounting the breaker resiliently in a frame and providing handles on the frame. The frame may be provided with at least one ground-engaging wheel. The manually operable control for the paving breaker may be mounted on the frame. Effective between the paving breaker and the frame are vibration-absorbing means in the form of rubber bushes. The paving breaker is able to reciprocate relative to the frame in a longitudinal direction.

GB-A-2098121 discloses a somewhat similar apparatus in which a percussive-action pneumatic tool is mounted in a frame so as to be movable longitudinally relative thereto, with the frame carrying the handles for manoeuvring the apparatus, and a shock-absorbing air cylinder device being coupled between the frame and the cylinder of the pneumatic tool. The frame rests on the ground by way of footplates in the form of respective bars with resilient covers in the form of rubber tubes.

In U.S. Pat. No. 5,462,127, a powered tool in the form of an axing chisel is mounted in a holder in the form of a trolley with ground wheels and handles which are employed instead of a handle on the powered tool. The handles are connected to the wheels by parallel, front uprights including parallel shock absorbers, whilst the powered tool is mounted on the wheels by way of a central, front upright, possibly through vibration damping elements, e.g. rubber bushings.

GB-A-2092938 discloses a pneumatic, rotary, percussive rock drill assembly including a telescopic air-powered leg. The drill and its operating mechanism are attached to the leg via a resilient damping assembly and the manoeuvring handle of the drill is attached to the leg side of the resilient damping assembly, which consists of twin cylinders within which are disposed respective helical springs and respective plungers. The handle assembly comprised of the resilient damping assembly and the handle is carried on the leg via a mounting lug.

According to the present invention, there is provided apparatus comprising a powered tool for working at material, a support for resting upon the ground or floor and which serves to support said tool in such manner that said tool is angularly manoeuvrable relative to said support, said tool incorporating a handle whereby said tool is angularly manoeuvrable as aforesaid, and vibration-absorbing means effective between said tool and said support to absorb vibration caused by operation of said tool.

Owing to the invention it is possible not only to avoid the need for a human operator to support the powered tool, which can be very tiring for him if the tool is heavy and which thus limits his output, but also to reduce the transmission of vibration to the support, whereby the support can be relatively lightly built, since the vibration-absorbing means reduces the vibrational stress to which the support would otherwise be subjected.

Advantageously, there is provided apparatus comprising a powered tool for working at material, a stand for supporting said powered tool, and actuating means for operating the tool located at the tool itself, for manual operation by an operator in the region of the tool. Thereby, it is possible to avoid any need to complicate the system by having the tool remotely actuated and manoeuvred.

The preferred embodiments of the present invention not only overcome the problem of the operator's having to support the tool, which is tiring and medically inadvisable, during overhead chiselling and/or drilling, but also their supports are of a lightweight construction and easily manoeuvrable. The preferred embodiments include vibration-absorbing means of any suitable material, but most preferably rubber. The rubber absorbs much of the spent vibrational energy, the rest being transmitted down through the supports themselves. The worker's contact with the apparatus is confined to a guiding hand on the tool and a trigger of the tool, the other hand being usable, in certain embodiments, to control the level and chiselling force of the tool.

In order that the invention may be clearly and completely disclosed, reference will now be made, by way of example, to the accompanying drawings, in which:

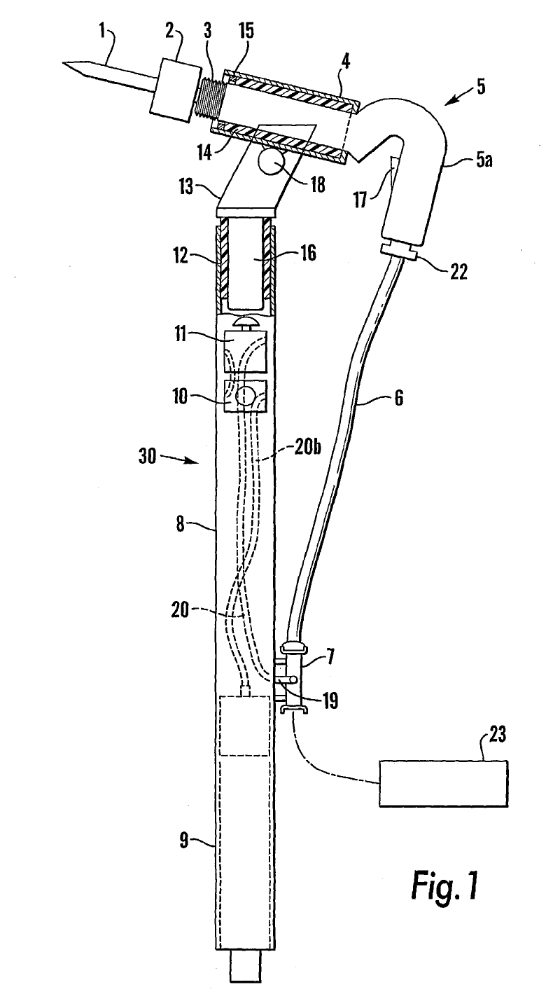

FIG. 1 is a fragmentary vertical section through part of an apparatus for use in working on a building surface,

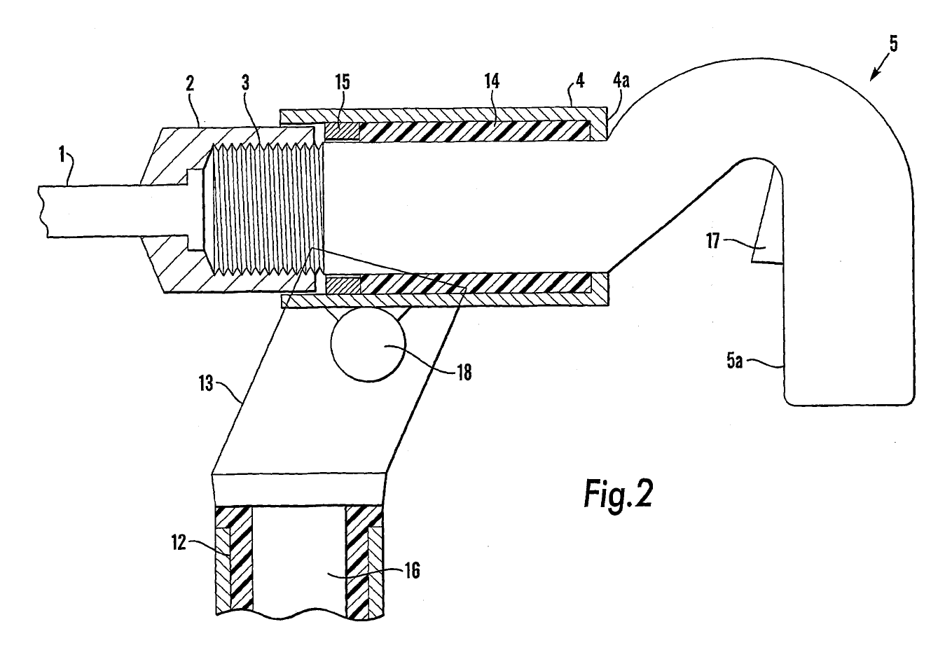

FIG. 2 is a view similar to FIG. 1, but showing in more detail a portion of that part of the apparatus,

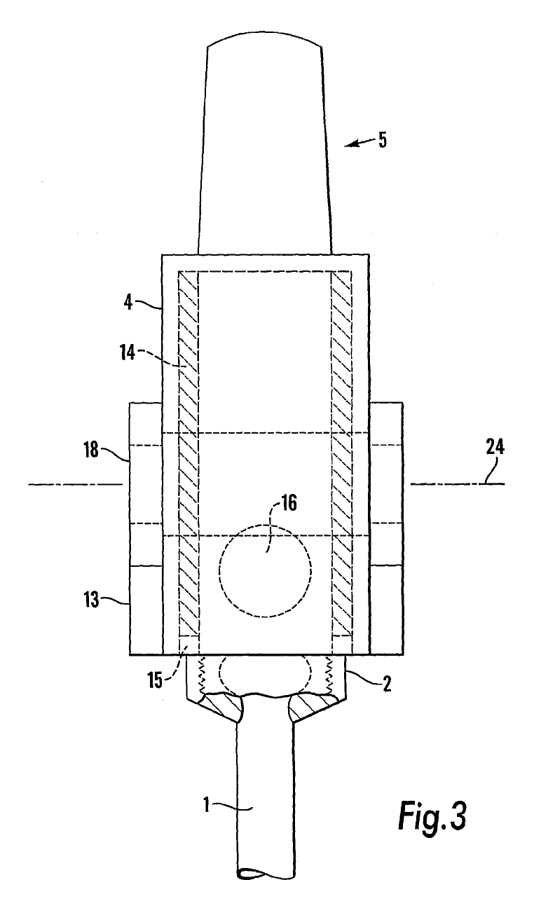

FIG. 3 is a fragmentary sectional plan view of that portion,

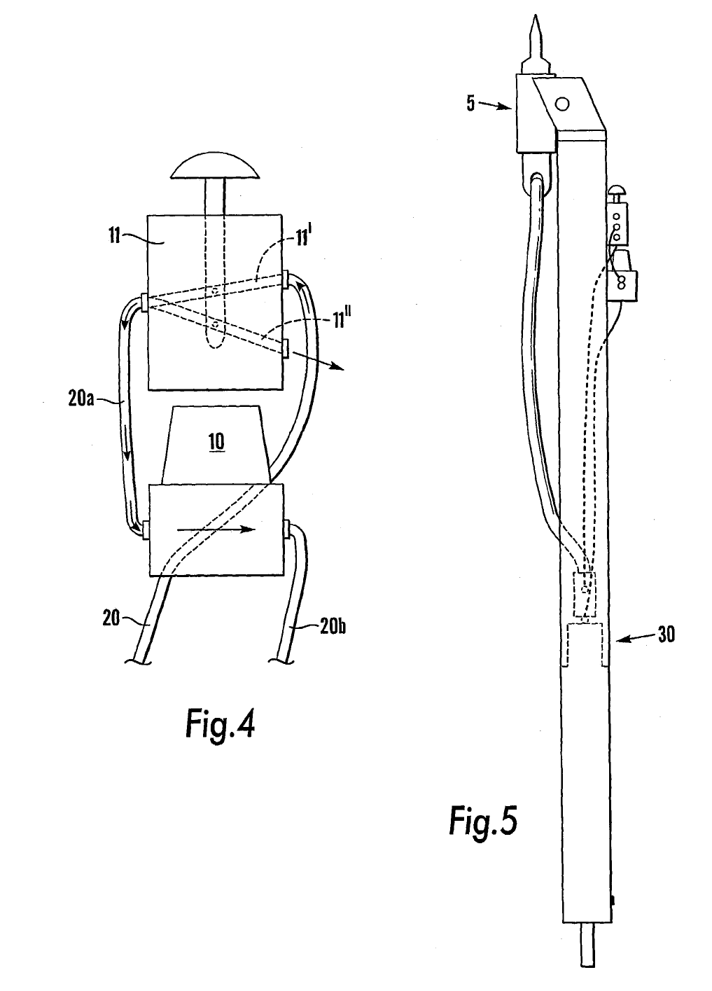

FIG. 4 shows a fragmentary diagrammatic view of a control valve arrangement of the apparatus,

FIG. 5 is a side elevation of that part set up for overhead work,

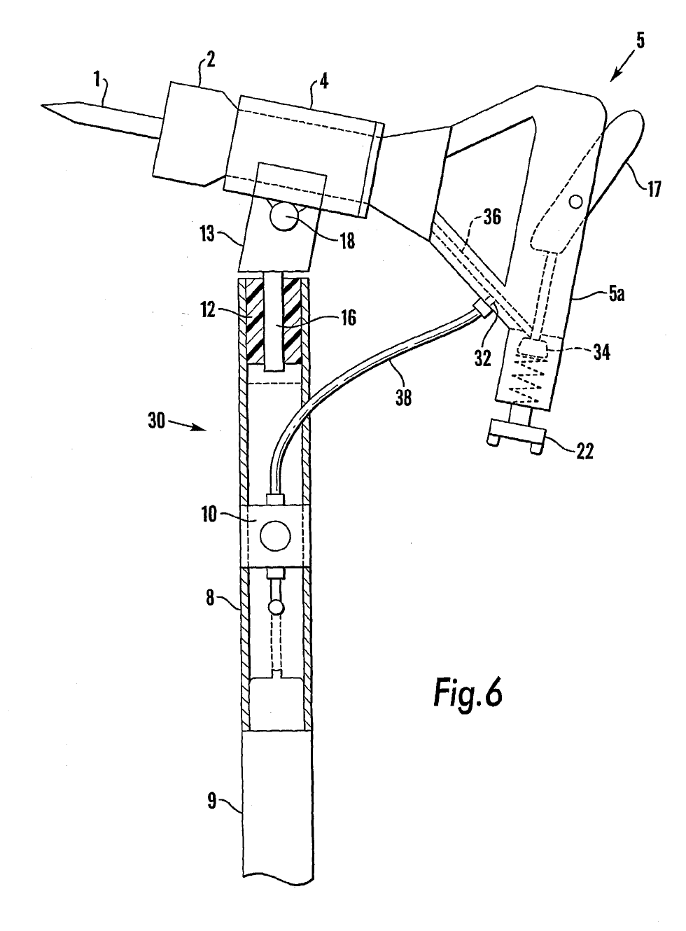

FIG. 6 is a view similar to FIG. 1 of part of a modified version of the apparatus, and

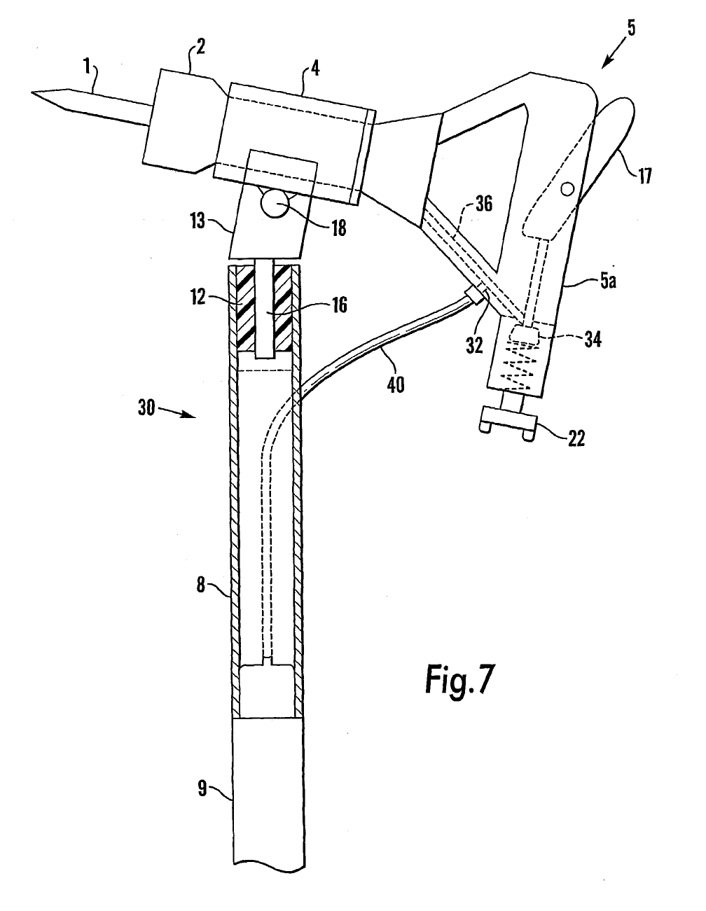

FIG. 7 is a view similar to FIG. 6 but of part of a further modified version of the apparatus.

Referring to FIGS. 1 to 5, in the following explanation, it is assumed that a pneumatic chiselling tool having a manoeuvering hand 5a is held by a supporting stand in the form of a jig 30. However, it will be appreciated that the tool could equally well be a pneumatic drilling or scathing tool, or an electrically or hydraulically driven chiselling, scathing or drilling tool or a similar tool.

The chiselling tool 5 is mounted in a rubber sleeve 14 inside a tubular holder 4. The tool 5 is shown in FIG. 1 with a chisel bit 1 inserted, but with a bit-locking cap 2 of the tool 5 not screwed into place on the external screwthread 3 of the tool. The tool 5 and its bit 1 do not weigh more than 10 kg, preferably not more than approximately 7 kg. In FIG. 2, the chisel bit 1 is shown locked into place by the bit-locking cap 2 being screwed fully home on the external thread 3. A load-spreading ring 15 lies between the locking cap 2 and an end of the rubber sleeve 14. The tubular holder 4 has an inwardly protruding flange 4a at a rearward end thereof, the arrangement being such that, upon tightening of the bit-locking cap 2 onto the powered tool at a forward end zone of the tool, the cap 2 presses the ring 15 rearwardly against the forward end of the sleeve 14 and thereby compresses against the flange 4a, the sleeve 14 which substantially co-axially receives the powered tool. In this way, a conventional tool 5 without its cap 2 can be inserted into the holder 4 and then firmly, but resiliently, retained therein. The assembly 4 is turnably fastened into a guide fork 13 by means of an axle bolt 18. A tubular part 16 of the guide fork 13 is inserted into a further rubber sleeve 12 which is flanged at its upper end and which in turn is inserted into a bearing tube 8, the lower end of which carries a pneumatically, hydraulically or electrically operated, vertically expanding device 9, such as a telescopic cylinder, ratchet, or wire lift. To be sufficiently robust to withstand the forces induced, the jig 30, save for the bearing tube 8, which may be of aluminium, is of steel construction and the guide fork 13 and the tubular holder 4 have a minimum wall thickness of 8 mm. Other materials can of course be used if dimensioned appropriately. The jig 30 may take the form of a pole which is not self-supporting and which is connected by way of a limited universal mounting to a disc which serves to sit upon the ground or floor. The pole incorporates the device 9.

For the sake of simplicity of description, only a pneumatic cylinder is shown as the device 9. A hose 6 passes from an air intake port 22 in the handle of the tool 5 to a standard connector 7 fitted to the bearing tube 8. The other end of this connector 7 is used for connection to a source of compressed air in the form of a compressor 23. The connector 7 is fitted with a port 19 from which a hose 20 is connected via a combined height-adjustment and air-release valve 11 and a hose 20a to a pressure regulator valve 10 itself connected via a hose 20b to the cylinder 9. Both of these valves 10 and 11 have control knobs situated to be convenient to the worker operating the apparatus. FIG. 4 indicates how the control valves 10 and 11 are connected to the cylinder 9 and the compressed air inlet 19.

The dead weight of the tool 5 and chisel bit 1 is carried by the bearing tube 8 and the cylinder 9. Vibrational forces are absorbed and dissipated by the rubber sleeves 12 and 14 and by the air in the cylinder 9. The function of the load-spreading ring 15 is to transmit vibrational forces to, and distribute them over, the adjacent end of the rubber sleeve 14. Having the load-spreading ring 15 present is an advantage since the ends of many known bit-locking caps now in use are bevelled or curved, which would lead to accelerated wear of the end of the rubber sleeve 14 were the ring 15 to be omitted. However, the arrangement would also be functional without the load-spreading ring 15. In use, the tool 5 tends to be knocked backwards in the tubular holder 4 when chiselling against a solid surface until it is brought up against the load-spreading ring 15, if present, or the rubber sleeve 14 if the load-spreading ring 15 is not present.

In use, the completely assembled jig 30 is placed upon a firm surface. The worker then adjusts the angle of the tool 5 by using the handle 5a to swing the tool 5 through the necessary vertical angle around the axis 24 of the bolt 18, and rotating it through the necessary horizontal angle around the axis of the bearing tube 8. Thus, the tool 5 is universally angularly manoeuvrable to a limited extent relative to the jig 30. The level of the tool 5, i.e. its height above the surface upon which the jig 30 is placed, is adjusted by the worker's operating the height adjustment valve 11 such that air is admitted into the cylinder 9. Before the height adjustment valve 11 is operated, the worker opens the pressure regulator valve 10 to an extent to control the rate of expansion of the cylinder 9. The height adjustment valve 11 has two settings. In a first setting 11′ the valve 11 supplies compressed air via the pressure regulator valve 10 to the cylinder 9. Some adjustment of the pressure regulator valve may be needed to compensate for the weight of the items supported by the cylinder 9. Once the required height has been reached, the worker adjusts the pressure regulator valve 10 to a lower setting to halt the continuing expansion of the cylinder 9 and obtain the correct height for the tool 5. When the correct height has been reached, the tool 5 is operated by means of its trigger 17. The chiselling pressure exerted by the tool 5 at angles near to the vertical as shown in FIG. 5 is adjusted by the worker operating the pressure regulator valve 10, the higher the pressure in the cylinder 9, the higher the pressure of the chisel bit 1 against the building material surface. At angles near to the horizontal, pressure may be brought to bear by the worker's pressing horizontally on the bearing tube 8, or by some other convenient arrangement. At intermediate angles a combination of the two pressing actions is used. When the chiselling operation is finished the height adjustment valve 11 is switched to a second setting 11″ in which the tool 5 is lowered by releasing the air from the cylinder 9.

In the version shown in FIG. 6, the compressed air for the tool 5 and the cylinder 9 is supplied to the tool 5 and branched off to the cylinder 9. The handle 5a of the tool 5 has an outlet port 32 in the form of a hole provided in the handle just downstream of the integral on/off air valve 34 of the tool 5. The port 32 is in communication with a compressed air supply conduit 36, which supplies compressed air through the tool 5 for operation of the chisel bit 1. Compressed air flow along the conduit 36 is controlled by operation of the air valve 34 which is located immediately above the air intake port 22 and operated by the trigger 17. The port 32 is connected to the pressure regulator valve 10 via a hose 38.

The method of use of the version of FIG. 6 is similar to that of the version of FIGS. 1 to 5, but with a number of differences which will now be described.

The level of the tool 5 is adjusted by the worker's operating the trigger 17 such that air is admitted into the cylinder 9 via the air supply conduit 36, the outlet port 32, the hose 38 and the pressure regulator valve 10. Before the trigger 17 is operated for height adjustment, the worker opens the pressure regulator valve 10 to an extent to control the rate of expansion of the cylinder 9. Thus, operation of the trigger 17 not only operates the chisel bit 1, but also supplies compressed air via the pressure regulator valve 10 to the cylinder 9. When the chiselling operation is finished and thus the valve 34 closed, the tool 5 gradually lowers by air escaping from the cylinder 9. This version eliminates the need for the height adjustment valve 11 and therefore simplifies the apparatus and its operational procedures.

It will be appreciated that adjusting the vertical and horizontal angles, and the chiselling pressure, are continuous iterative and interactive operations which are undertaken by the worker as work progresses.

In the version shown in FIG. 7, even the pressure regulator valve 10 is omitted, and the port 32 in the handle 5a of the tool 5 is connected directly to the cylinder 9 via a hose 40. However, this modification is only usable when chiselling vertically upwards into hard material, since the arrangement does not allow pressure in the cylinder 9 to be regulated. By operating the trigger 17, air is admitted into the cylinder 9 via the hose 40, which causes the tool to rise until brought to rest against a downwards facing, substantially horizontal surface. The pressure exerted by the tool will now depend entirely upon the air pressure from the compressor and the internal diameter of the cylinder 9. For this reason, the diameter of the cylinder 9 is carefully selected, otherwise the pressure exerted by the compressed air from the compressor may make the tool unmanageable. An internal diameter of the pneumatic cylinder of around 30 mm gives a manageable tool when using normal compressor air pressures of 7 bars. Air is continually admitted into the cylinder 9 throughout the work being done, to maintain the upward chiselling pressure of the tool 5 against the surface being worked. When the chiselling operation has finished and thus the valve 34 closed, the tool 5 gradually lowers by air escaping from the cylinder 9.

It will also be appreciated that, although the above description is from the aspect of pneumatic chiselling, the principles thereof are easily adapted to any type of tool to be used in similar fashion, such as scathers, drills, saws, grinders, and needle guns.

An advantage of the embodiments described with reference to the drawings is that the worker is not subjected to the fatigue of continuously supporting a comparatively heavy tool. In addition, the amount of vibrational energy transmitted to the worker by the jig is minimal. These factors combine to result in a worker's daily output being greatly increased. In the case of overhead chiselling, for example, it is believed that workers' output would increase by a factor of at least 3 or 4 with no sign of the fatigue, numbness, tingling, and shaking induced by conventional chiselling and which are indicative of degenerative bodily harm and, therefore, the described embodiments would make the task of tooling hard materials much more humane. The total assembly is comparatively light in weight and can easily be carried and installed on site by one man.

1. Apparatus comprising a powered tool for overhead working at material, a support for resting upon the ground or floor and which serves to support said tool in such manner that said tool is angularly manoeuvrable relative to said support, said tool incorporating a handle whereby said tool is angularly manoeuvrable as aforesaid, and vibration-absorbing means effective between said tool and said support to absorb vibration caused by operation of said tool.

2. Apparatus according to claim 1, wherein said support is effective with respect to said tool at a location intermediate first and second ends of said tool.

3. Apparatus according to claim 1 or 2, wherein said tool is supported by said support by way of a substantially horizontal pivot axis.

4. Apparatus according to claim 1, 2 or 3, wherein said tool is supported by said support in such manner as to be universally angularly manoeuvrable to a limited extent.

5. Apparatus according to any preceding claim, wherein said vibration-absorbing means comprises an elastomeric sleeve arranged to receive said powered tool substantially co-axially.

6. Apparatus according to claim 3, or claim 4 or 5 as appended to claim 3, and further comprising a guide fork having a main stem thereof mounted on said support and serving to carry said powered tool between branch limbs thereof so that the powered tool is turnable about said substantially horizontal pivot axis relative to the guide fork.

7. Apparatus according to claim 6 as appended to claim 5, and further comprising a tubular holder substantially co-axially encircling said elastomeric sleeve and horizontally pivotally mounted between said branch limbs.

8. Apparatus according to claim 6 or 7, wherein said vibration-absorbing means comprises an elastomeric sleeve substantially co-axially receiving said main stem and mounted in a substantially co-axial tubular portion of said stand.

9. Apparatus according to claim 7, or claim 8 as appended to claim 7, wherein said tubular holder has an inwardly protruding ring at a rearward end region thereof, the arrangement being such that, upon tightening of a bit-locking cap onto the powered tool at a forward end zone thereof, the cap compresses against said inwardly protruding ring said elastomeric sleeve substantially co-axially receiving said powered tool.

10. Apparatus according to claim 9, and further comprising a load-spreading ring substantially co-axial with said tubular holder and received therein at a forward end region thereof, the arrangement being such that, upon tightening of said bit-locking cap onto the tool at said forward end zone thereof, the cap presses said load-spreading ring rearwardly against the forward end of said elastomeric sleeve substantially co-axially receiving said powered tool and thereby compresses that sleeve against said inwardly protruding ring.

11. Apparatus according to any preceding claim, wherein said support includes a vertically expanding device for lifting and lowering said powered tool.

12. Apparatus according to claim 11, wherein said tool is pneumatically powered and said vertically expanding device comprises a pneumatic piston-and-cylinder motor.

13. Apparatus according to claim 12, and further comprising height-adjustment and air-release valve means communicating with said motor for use i n respectively inflating and deflating said motor.

14. Apparatus according to claim 12 or 13 and further comprising pressure regulating valve means communicating with said motor for regulating the pressure in said motor.

15. Apparatus according to any one of claims 12 to 14, wherein said tool is upstream of said motor in relation to pneumatic supply thereto.

16. Apparatus according to claim 15 as appended to claim 13, wherein the valve means and control means therefor are provided on said tool.

17. Apparatus according to claim 16, wherein said control means comprises an operating trigger of said tool.

18. Apparatus according to claim 13 or 14, wherein control means for the valve means is provided on said support.

19. Apparatus according to any preceding claim, wherein said support is light in weight.

20. Apparatus according to claim 19, wherein said support is easily manoeuvrable.
